(19) United States
(12) Patent Application Publication
(10) Pub. No.: US 2012/0075186 A1
(43) Pub. Date: Mar. 29, 2012

(54) BENDABLE MOUSE

(75) Inventors: TSUNG-SHIH LEE, Tu Cheng (TW); Yu-hsiang Ting, Tu Cheng (TW)

(73) Assignee: Cheng Uei Precision Industry Co., Ltd., Tu Cheng City (TW)

(21) Appl. No.: 12/892,845

(22) Filed: Sep. 28, 2010

(51) Int. Cl. G06F 3/033

(52) U.S. Cl. 345/163

(57) ABSTRACT

Disclosed is a bendable mouse, comprising an operating portion, a bendable portion and a rubber body. The bendable portion comprises a base and a bendable body. The base is fixed to the operating portion. The base comprises a base plate and an attached body. The base plate is jointed with the bendable body. The attached body is fixed with the base plate. A fixing block is positioned at the attached body. The rubber body covers the bendable portion and comprises a base joint sleeve and bendable sleeve. An inserter is formed at the bendable sleeve toward the inside of the base joint sleeve and inseparably adheres with the fixing block. The bendable mouse can prevent the separation phenomenon of the rubber body from the base and ensures the rubber body to remain adhering closely with the bendable portion when it changes from the curved status to the straight status.

### BACKGROUND OF THE INVENTION

1. Field of the Invention

The present invention generally relates to a mouse, and more particularly to a bendable mouse.

2. Description of Prior Art

Please refer to FIG. 9, which shows an exploded assembly diagram of a bendable mouse 100′ according to prior art. The bendable mouse 100′ comprises an operating portion 10′, a bendable portion 20′ and a rubber body 30′ covering the outer surface of the bendable portion 20′. The bendable portion 20′ comprises a base 21′ and a multisession bendable body 22′ connected with the base 21′. The base 21′ is fixed to the operating portion 10′. A lateral surface (not indicated) is formed at the upper part of one side of the base 21′ facing the bendable body 22′ and an attached surface 211′ with an curved surface formed at the lower part of the side of the base 21′. The lateral surface is jointed with one lateral surface of the swing bendable body 22′. The rubber body 30′ comprises a base joint sleeve 31′ and bendable sleeve 32′. The base joint sleeve 31′ is attached with the attached surface 211′ of the base 21′. The bendable sleeve 32′ covers the surface of the bendable body 22′.

However, One manufacture method of forming the rubber body 30′ is to be provided in a straight status. The bendable sleeve 32′ of the rubber body 30′ appears some irregular levitating bubbles due to the elastic characteristic when the bendable mouse 100′ is bent.

Another manufacture method of molding the rubber body 30′ is to be provided in curved status. The bendable sleeve 32′ of the rubber body 30′ may become separated from the attached surface 211′ of the base 21′ when the bendable mouse 100′ becomes straight.

### SUMMARY OF THE INVENTION

For solving the drawbacks of aforementioned prior art, an objective of the present invention is to provide a bendable mouse capable of preventing levitating bubbles occurred on the rubber body or separation phenomenon of the rubber body from the base.

For realizing the aforesaid objective, the bendable mouse of the present invention comprises an operating portion, a bendable portion and a rubber body. The bendable portion comprises a base and a bendable body connected with the base. The base is fixed to one end of the operating portion. The base comprises a base plate and an attached body. One end surface of the base plate is jointed with a lateral end of the bendable body. The attached body is fixed with a lateral surface of the base plate. A fixing block is positioned at a side of the attached body facing the base plate. An attached surface is formed at a side of the attached body facing the bendable body. The rubber body covers the outer surface of the bendable portion. The rubber body comprises a base joint sleeve and bendable sleeve. The bendable sleeve has a curved shape. An inserter is formed at one end of the bendable sleeve toward the inside of the base joint sleeve. The inserter inseparably adheres with the fixing block.

As aforementioned, with the bendable sleeve to be formed in a curved status the bendable mouse of the present invention can prevent the levitating bubbles occurred on the rubber body. Meanwhile, with the inserter formed at the end of bendable sleeve toward the inside of the base joint sleeve and to be adhered with the fixing block, the separation phenomenon of the rubber body from the base can be prevented and the rubber body can be ensured to remain adhering closely with the bendable portion when the bendable mouse changes from the curved status to the straight status.

### BRIEF DESCRIPTION OF THE DRAWINGS

FIG. 1 shows a three dimensional view diagram of a first embodiment of a bendable mouse according to the present invention.

FIG. 2 shows a three dimensional view diagram of the bendable mouse shown in FIG. 1 in a straight status.

FIG. 3 shows an exploded view diagram of the bendable mouse shown in FIG. 2.

FIG. 4 shows an exploded view diagram of the base of the bendable mouse shown in FIG. 3.

FIG. 5 shows a three dimensional view diagram of the attached body of the bendable mouse shown in FIG. 4.

FIG. 6 shows a three dimensional view diagram of the rubber body shown in FIG. 1.

FIG. 7 shows a three dimensional view diagram of the attached body and the rubber body of the bendable mouse shown in FIG. 1 in combination.

FIG. 8 shows a cutaway View diagram of the attached body and the rubber body of the bendable mouse shown in FIG. 1 in combination.

FIG. 9 shows an exploded assembly diagram of a bendable mouse according to prior art.

### DETAILED DESCRIPTION OF THE INVENTION

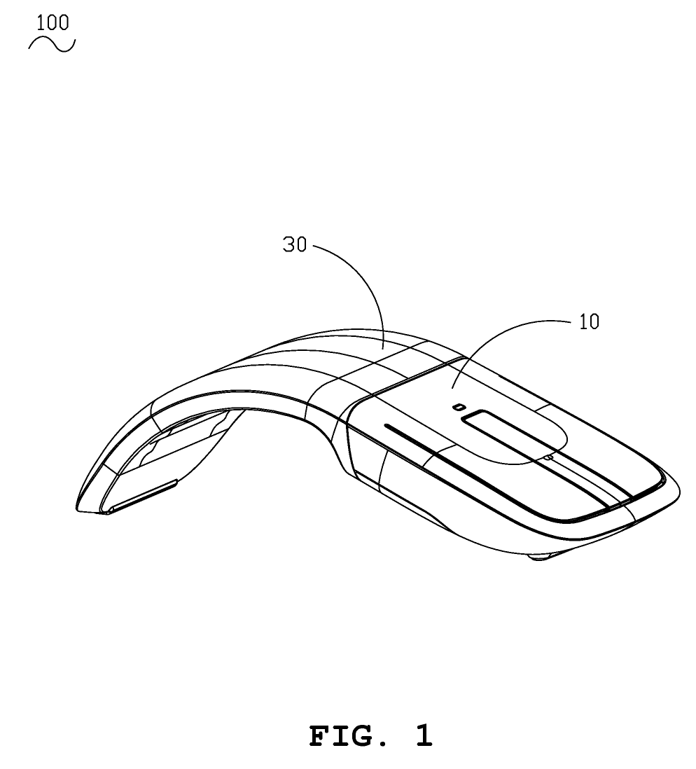

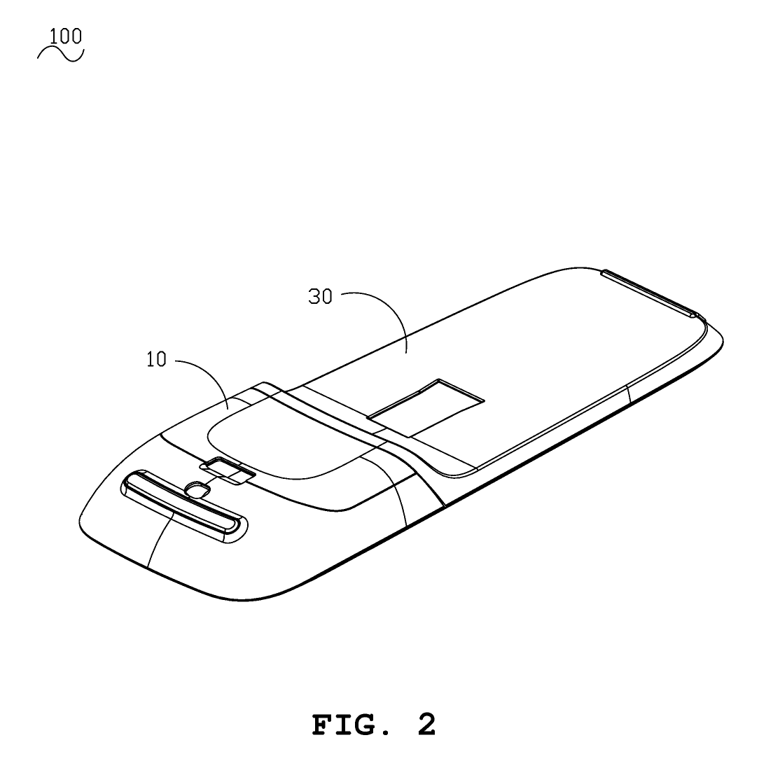

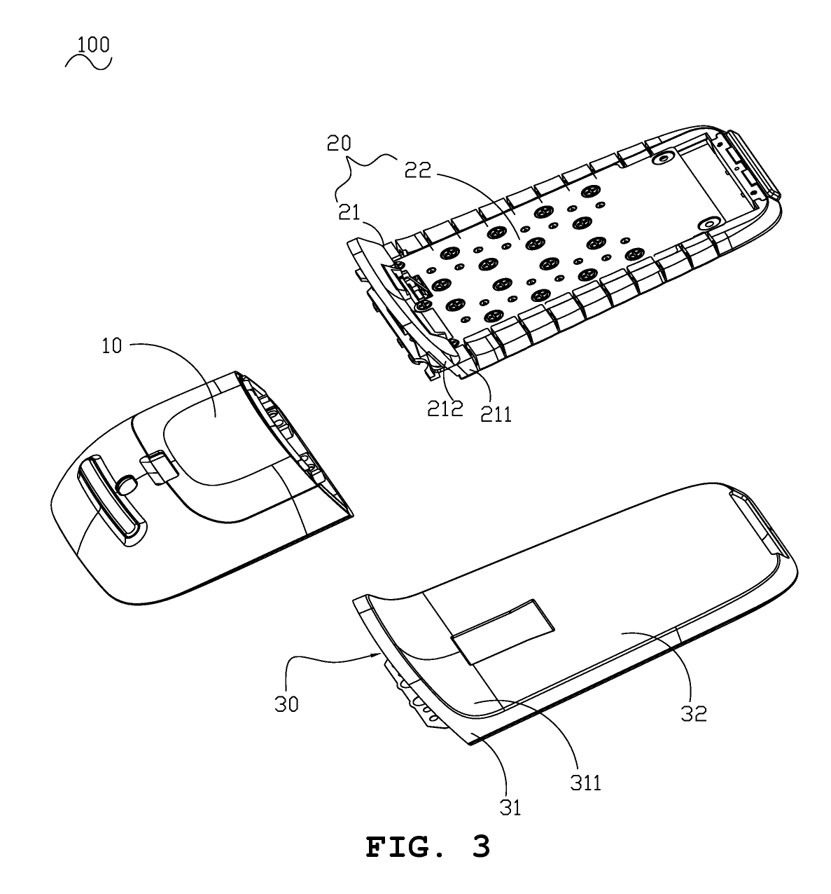

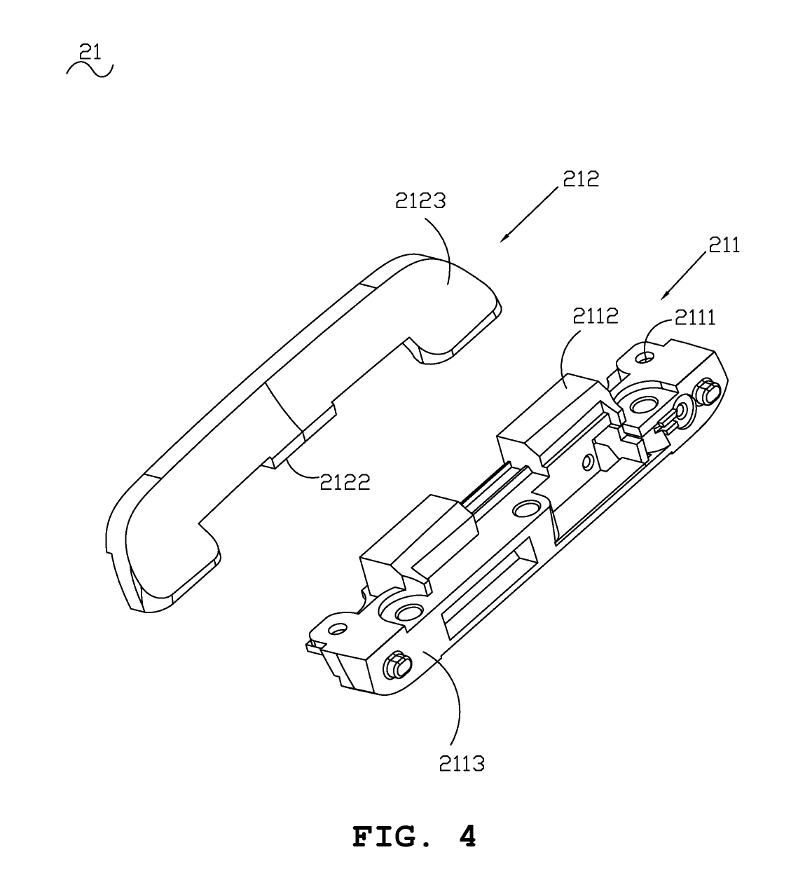

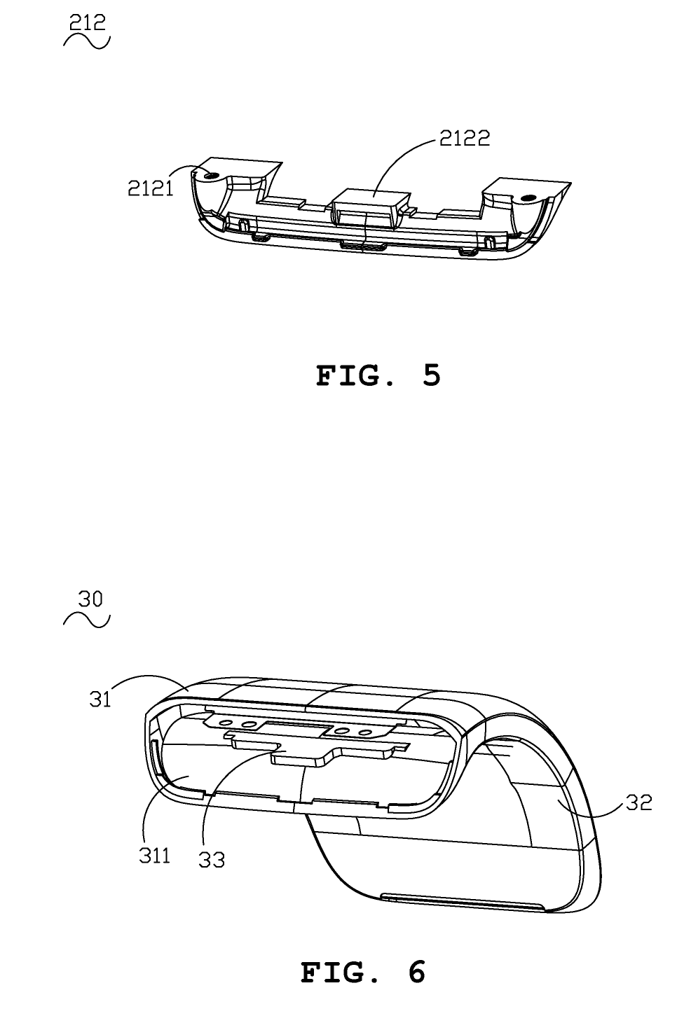

Please refer to FIG. 1, FIG. 2 and FIG. 3. The bendable mouse 100 of the present invention comprises an operating portion 10, a bendable portion 20 and a rubber body 30. Please refer to FIG. 3, FIG. 4 and FIG. 5. The bendable portion comprises a base 21 and a multisession bendable body 22 connected with the base 21. The base 21 is fixed to one end of the operating portion 10. The base 21 comprises a base plate 211 which is slaty shaped and an attached body 212. One lateral end surface 2113 of the swing base plate 211 facing the bendable body 22 is jointed with a lateral end of the bendable body 22. Two joint holes 2111 are formed at the two sides of base plate 211. Two bumps 2112 are formed outward the lateral surface of the base plate 211. The attached body 212 is made of zinc alloy material and fixed with a lateral surface of the base plate 211. Two joint troughs 2121 are formed at the two sides of the attached body 212. A fixing block 2122 is positioned at the attached body 212 in accordance with the position between the two bumps 2112 of the base plate 211. A curved attached surface 2123 is formed at a side of the attached body 212 facing the bendable body 22. The joint troughs 2121 and the joint holes 2111 are jointed with each other by screws (not shown).

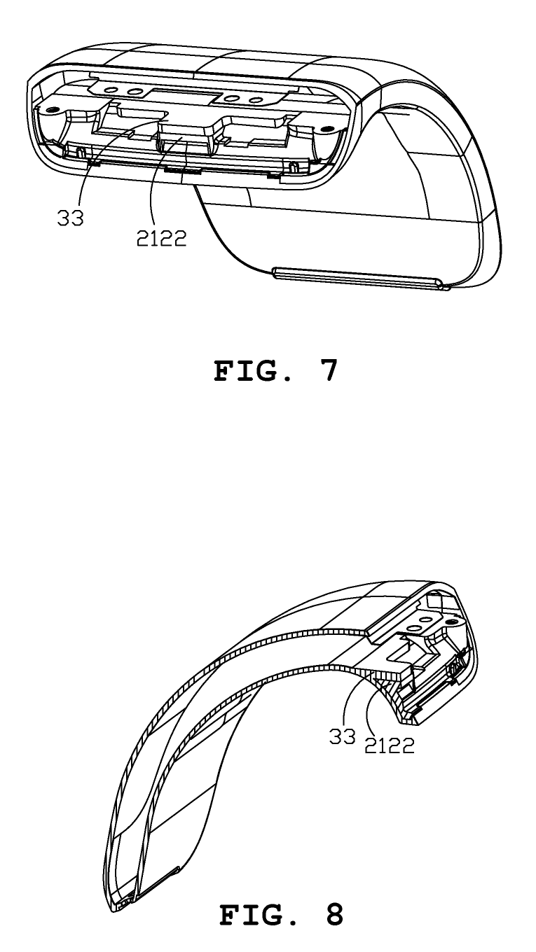

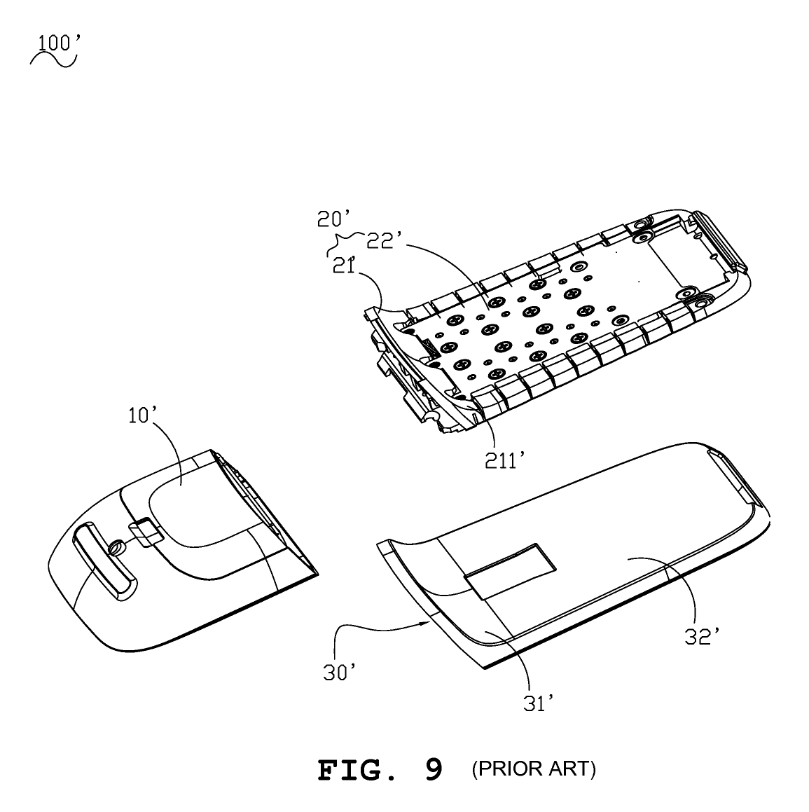

Please refer to FIG. 3, FIG. 6, FIG. 7 and FIG. 8. The rubber body 30 is sleeve jointed to the bendable portion 20 and covers the outer surface of the bendable portion 20. The rubber body 30 comprises a base joint sleeve 31 and bendable sleeve 32. The base joint sleeve 31 comprises an attaching cuff 311 for attaching and adheres to the attached surface 2123. The bendable sleeve 32 has a curved shape. An inserter 33 is formed at one end of bendable sleeve 32 close to the attaching cuff 311 and toward the inside of the base joint sleeve 31. Accordingly, the base joint sleeve 31 can be attached to the base 21. The bendable sleeve 32 is utilized to sleeves and covers the surface of bendable body 22. The inserter 33 is mold formed and inseparably adheres with the fixing block 2122.

Please refer to FIG. 1, FIG. 2, FIG. 7 and FIG. 8. When the bendable mouse 100 changes from the curved status to the straight status, the rubber body 30 also becomes straight. Because the inserter 33 is inseparably adheres with the fixing block 2122 of the attached body 212, the base joint sleeve 31 of the rubber body 30 can remain to adheres closely to the base 21. Therefore, the separation phenomenon of the attaching cuff 311 of the rubber body 30 from the attached surface 2123 of the bendable portion 20 can be prevented.

As aforementioned, the bendable mouse 100 of the present invention is capable of preventing levitating bubbles occurred on the rubber body 30 with the bendable sleeve 32 of the rubber body 30 to be formed in curved shape. Meanwhile, with the inserter 33 formed at one end of bendable sleeve 32 close to the attaching cuff 311 and toward the inside of the base joint sleeve 31, the rubber body 30 can be ensured to remain adhering closely with the bendable portion 20 and the separation phenomenon of the rubber body 30 from the bendable portion 20 can be prevented when the bendable mouse 100 changes from the curved status to the straight status.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A bendable mouse, comprising:
an operating portion;
a bendable portion, comprising a base and a bendable body connected with the base, wherein the base is fixed to one end of the operating portion and the base comprises a base plate and an attached body, wherein one end surface of the base plate is jointed with a lateral end of the bendable body, the attached body is fixed with a lateral surface of the base plate, a fixing block is positioned at a side of the attached body facing the base plate, an attached surface is formed at a side of the attached body facing the bendable body; and
a rubber body, covering the outer surface of the bendable portion, wherein the rubber body comprises a base joint sleeve and bendable sleeve, the bendable sleeve has a curved shape, an inserter is formed at one end of the bendable sleeve toward the inside of the base joint sleeve and the inserter inseparably adheres with the fixing block.

2. The bendable mouse of claim 1, wherein the base joint sleeve further comprises attaching cuff for attaching the attached surface and two bumps are formed outward a lateral surface of the base plate, which the fixing block is positioned therebetween.

3. The bendable mouse of claim 1, wherein the attached body is made of zinc alloy material.
